(19) United States
(12) Patent Application Publication
(10) Pub. No.: US 2025/0144553 A1
(43) Pub. Date: May 8, 2025

(54) SYSTEMS AND METHODS FOR FILTRATION MAINTENANCE AND OPERATION

(71) Applicant: Research Products Corporation, Madison, WI (US)

(72) Inventors: Jatin Khanpara, Madison, WI (US); Goulian Wu, Madison, WI (US); Gerald McNerney, Madison, WI (US); Travis J. Blackburn, Madison, WI (US)

(73) Assignee: Research Products Corporation, Madison, WI (US)

(21) Appl. No.: 18/913,019

(22) Filed: Oct. 11, 2024

Related U.S. Application Data
(60) Provisional application No. 63/596,052, filed on Nov. 3, 2023.

(51) Int. Cl. B01D 46/00; F24F 11/39; F24F 110/64; G01N 15/08

(52) U.S. Cl. CPC B01D 46/0086; F24F 11/39; G01N 15/08; B01D 2279/50; F24F 2110/64; G01N 2015/084

(57) ABSTRACT

A system can determine a first measure of particulate matter generated from particulate sources disposed within a structure based at least in part on occupant data for the structure. The system can determine a second measure of particulate matter generated from an environment comprising particulate sources disposed outside the structure. The system can predict a service life for a filter based at least in part on the first measure of particulate matter, the second measure of particulate matter, and properties of the filter. The system can present an indication of the predicted service life for the filter.

### RELATED APPLICATIONS

This application claims priority to U.S. Provisional Patent Application No. 63/596,052, filed Nov. 3, 2023, the entire contents of which are incorporated herein by reference.

### BACKGROUND

The present application relates generally to the field of climate control systems. More specifically, the present disclosure relates to systems, methods, and devices for maintenance and operation of filters and other components of such systems.

### BRIEF DESCRIPTION OF THE DRAWINGS

FIG. 1 is a block diagram of a ventilation system, according to an embodiment of the present disclosure.

FIG. 2A is a depiction of a flow model including a structure disposed within an environment, according to an embodiment of the present disclosure.

FIGS. 2B, 2C, and 2D depict flow models for structures including various ventilation profiles, according to an embodiment of the present disclosure.

FIG. 3 depicts a data structure including particulate matter generation information for various particulate matter sources of a structure, according to an embodiment of the present disclosure.

FIG. 4 is a filter life graph, according to an embodiment of the present disclosure.

FIG. 5 is a method of operating a ventilation system, according to an embodiment of the present disclosure.

FIG. 6 is a block diagram illustrating an architecture for a computer system that can be employed to implement elements of the systems and methods described and illustrated herein.

### SUMMARY

In some aspects, a system for ventilation is provided. The system can include one or more processors coupled to memory. The one or more processors can be configured to determine a first measure of particulate matter generated from particulate sources disposed within a structure based at least in part on occupant data for the structure. The one or more processors can be configured to determine a second measure of particulate matter generated from an environment comprising particulate sources disposed outside the structure. The one or more processors can be configured to predict a service life for a filter based at least in part on the first measure of particulate matter, the second measure of particulate matter, and properties of the filter. The one or more processors can be configured to present an indication of the predicted service life for the filter.

In some aspects, a method is provided. The method can be performed by one or more processors coupled to memory. The method can include determining a first measure of particulate matter generated from particulate sources disposed within a structure based at least in part on occupant data for the structure. The method can include determining a second measure of particulate matter generated from an environment comprising particulate sources disposed outside the structure. The method can include predicting a service life for a filter based at least in part on the first measure of particulate matter, the second measure of particulate matter, and properties of the filter. The method can include presenting, by the one or more processors, an indication of the predicted service life for the filter.

In some aspects, a non-transitory computer-readable is provided. The memory can include computer-readable instructions stored thereon. The instructions can be executed by a processor to cause a processor to determine a first measure of particulate matter generated from particulate sources disposed within a structure based at least in part on occupant data for the structure. The instructions can further cause the processor to determine a second measure of particulate matter generated from an environment comprising particulate sources disposed outside the structure. The instructions can further cause the processor to predict a service life for a filter based at least in part on the first measure of particulate matter, the second measure of particulate matter, and properties of the filter. The instructions can further cause the processor to present an indication of the predicted service life for the filter.

### DETAILED DESCRIPTION

Various climate control systems, including heat pumps, dehumidifiers, air conditioning systems, air purification systems and the like, can include ventilation systems. The ventilation systems can circulate air within the structure or between a structure and a surrounding environment. The structure can include particulate matter originating from sources within the structure or the surrounding environment. For example, pet dander, dried skin, smoke, dust, allergens, or environmental pollution such as smog may originate from within or outside the structure. The ventilation systems may pass airflow through a filter to remove particulate matter from the air. Thus, to determine a state for a filter (e.g., an expected or remaining service life), it may be useful to determine any particulate matter sources disposed within or outside of the structure, along with a rate of exchange of air therebetween.

According to various embodiments disclosed herein, a ventilation system can receive an indication of particulate matter originating from sources within and outside of a structure, and determine the service life of a filter based thereupon. The service life can be based on an aggregate level of particulate matter or one or more particulate types or characteristics, such as a particulate matter size or category (e.g., viruses, pollen, etc.). The filter service life can be determined upon a receipt of information. The information can relate to particulate sources within the structure such as pets, human occupants, or industrial equipment. The information can relate to particulate sources outside of the structure such as a prevailing wind, temperature, or geographic location. The information can relate to the structure such as a method of construction, volume, or facing (e.g., north facing, west facing, etc.) of one or more portions. In some embodiments, the ventilation system can receive updates relating to the ventilation system (e.g., to a temperature of an environment, a usage of a climate control or other ventilation system, or a prevalence of allergens surrounding the structure). The ventilation system can update the filter life responsive to the receipt of information, periodically, or continuously. In some embodiments, the ventilation system can adjust the operation of the ventilation system based on the updated information.

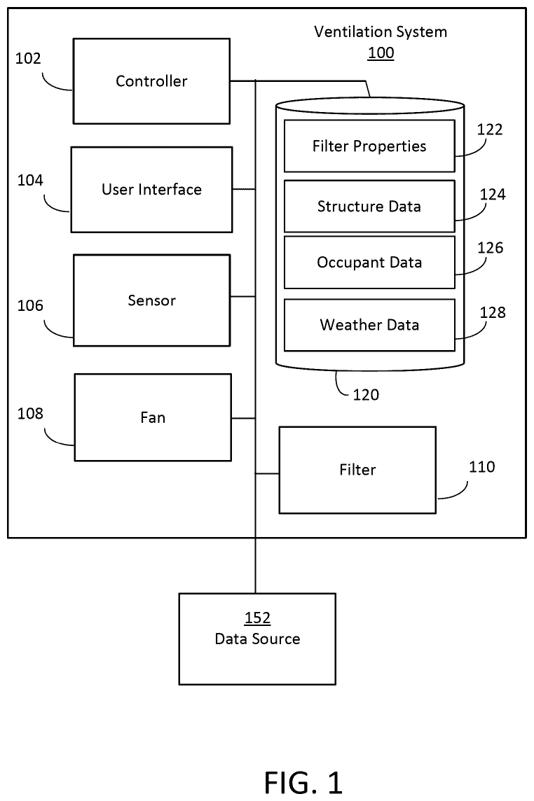

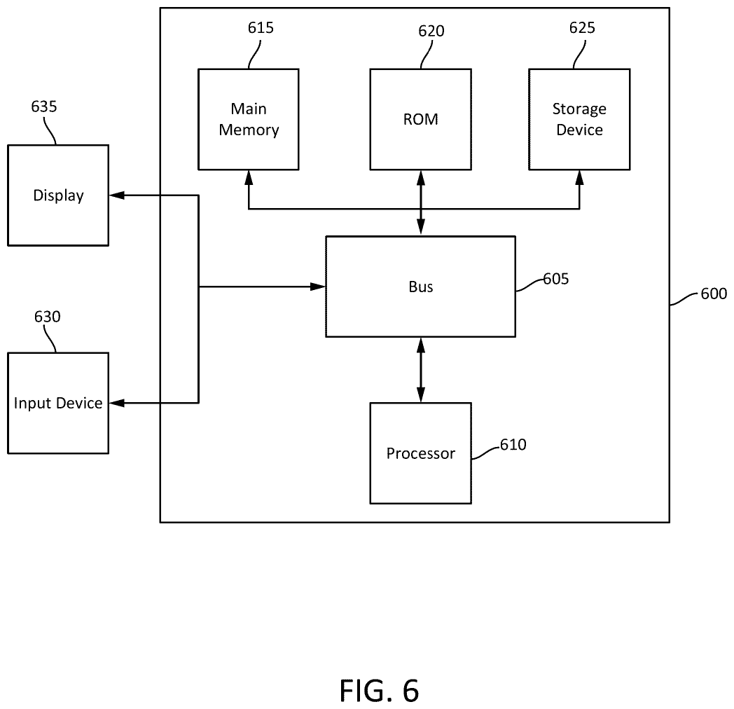

FIG. 1 is a block diagram of a ventilation system 100, according to an embodiment of the present disclosure. The ventilation system 100 can include a controller 102; user interface 104 to exchange information with a user; any number of sensors 106 to determine an occupancy of a structure, air quality interior or exterior to the structure, or so forth; a fan 108 to circulate air within the structure, between the structure and an environment, or through a filter 110; or the filter 110 to collect particulate matter entrained in air passing there-though. The controller 102 can include at least one processing unit or other logic device such as a programmable logic array engine, or module configured to communicate with the data repository 120 or database, or interface with various software stored on a memory thereof. The controller 102, user interface 104, or sensors 106 can be separate components, nested components, or part of the ventilation system 100. For example, the controller 102 can instantiate a graphical display for the user interface 104 and convey information of the user interface 104 over one or more network connections. The ventilation system 100 can include hardware or software elements, such as one or more processors, logic devices, or circuits. For example, the ventilation system 100 can include one or more components or structures of functionality of computing devices depicted in FIG. 6.

FIG. 1, like the other figures described herein, is not intended to be limiting. Indeed, the systems and methods of this disclosure can be applied to various applications. For example, although the present figure refers to a ventilation system 100, the systems and methods herein can be employed to determine air quality for various structures such as structures with passive air movement, or lacking filters 110.

The ventilation system 100 can interface with one or more data sources 152. The data sources 152 can provide an association between occupant data 126 or structure data 124 with an amount of particulate matter generated. For example, the data sources 152 can include a lookup table to associate occupant data 126 or structure data 124 with an amount or type of particulate matter generation associated therewith. The data sources 152 may be external to the structure or the ventilation system, such as a remote server, included on the data repository 120, or distributed therebetween. An external data source 152 can provide sensor data for one or more sensors 106 which are remote from the structure (e.g., weather satellites, smog sensors 106, wind speed sensors 106, etc.). For example, the data source 152 may include a weather service which may provide weather data 128, location data, or an association between a structure and an expected airflow or particulate matter flow between the structure and the environment. The various sensor data referred to herein may be received via the external data source 152, or from a sensor 106 local to the structure, except where clearly imperatively (e.g., weather satellites in the structure).

The data repository 120 can include one or more local or distributed databases, and can include a database management system. The data repository 120 can include computer data storage or memory and can store one or more of a filter property 122, structure data 124, occupant data 126, or weather data 128.

The filter properties 122 can include or refer to data associated with a filter 110. For example, filter properties 122 can include surface area, efficiency for one or more size of particulate matter, an electrostatic charge, filter material, or the like. The filter properties 122 can correspond to one or more filter model numbers. For example, a ventilation system 100 can be associated with one or more filter sizes or types, wherein a user may select a filter 110 from one or more manufacturers, having one or more minimum effective reporting values (MERV) values, or so forth. Various filter properties 122 can be associated with one or more filters 110. For example, first filter properties 122 may be associated with a “high flow” filter 110, second filter properties 122 may be associated with a “high filtration” filter 110, and third filter properties 122 can be associated with a “balanced” filter 110. Some ventilation system 100 may include more than one filter 110. The filter properties 122 can include information for each filter 110 or filter type. Filter properties 122 can include an installation date, service date, or other information particular to an instance of a filter 110.

The structure data 124 can include or refer to data associated with a structure. For example, the structure data 124 may include a volume of the structure, height of a structure, or a rate of air exchange between the structure and an environment. The exchange of air can include an estimated elevation of the exchange of air or an exchange rate of particulate matter along with the air. For example, some air (e.g., near ground level) can entrain differently sized (e.g., larger) particles for transport into the structure. The structure data 124 may include a construction type such as an energy efficiency rating, or a number or type of particulate matter sources of the structure such as wood burning fireplaces, pellet stoves, candles, or incense. The structure data 124 can include an association with an adjoining structure, as in the case of apartment buildings or duplexes. The structure data 124 can include various information indicative of air exchange between a structure and an environment. For example, the structure data 124 can include a year of construction and a climate zone or region, which may be indicative of the air exchanged with an environment. The structure data 124 can include indications of surface finishings of interiors such as surface finishes of walls, ceilings, or floors.

The occupant data 126 can include or refer to data corresponding to occupants of a structure. For example, occupant data 126 can include a number or type of occupants (e.g., adult, child, dog, gerbil). The occupant data 126 can include an amount of time the occupants occupy the house, activities they engage in, etc. For example, some activities or equipment employed by occupants may be relevant to a generation of particulate matter within the structure. Such occupant data 126 can include keeping of plants associated with pollen generation, industrial equipment which can generate particulate matter, incense, wood burning fireplaces, cigarette smoking, and so forth. Occupant data 126 may further include user preferences for one or more occupants. For example, a user may be particularly sensitive to smoke, allergens such as pollen, or so forth.

The ventilation system can associate each portion of occupant data 126 with an amount or type of particulate matter associated therewith. For example, each person or animal may be associated with an amount of biological particulate matter including dander or other sloughed off skin. Cigarettes, candles, or other burning materials may be associated with an amount of smoke including particulate matter. Plants may be associated with pollen, and so forth. The particulate matter may include a type such as a size, allergenic profile, or so forth. For example, human and pet dander may be of different size or allergenic potential which may be stored as a part of the occupant data 126. The occupant data 126 can include time averages or current information. For example occupancy can be determined according to a user input (e.g., average occupancy of 12 hours a day, time when a child or pet is in daycare, etc.) or a sensor 106 can determine a presence of a user, such as according to a motion sensor 106, or a presence of a mobile device associated with the occupant.

The weather data 128 can include or refer to information regarding an environment around a home. For example, the weather data 128 can include an exterior temperature, smog level, dust level, or allergen level (e.g., pollen). The weather data 128 can include time averages (e.g., average heating degree days, cooling degree days, a prevailing direction or speed of wind, or so forth). The weather data 128 can include live weather data such as a daily, hourly, or minutely temperature, wind speed or direction, or pollen levels, historical data, or forecasted data, any of which may be referred to as ambient weather. For example, the forecasted data can include historical averages which are employed for various predictions.

The ventilation system 100 can include, interface with, or otherwise utilize at least one controller 102. The controller 102 can include or interface with one or more processors and memory, or any of the elements depicted in FIG. 6. The processor can be implemented as a specific purpose processor, an application specific integrated circuit (ASIC), one or more field programmable gate arrays (FPGAs), a group of processing components, or other suitable electronic processing components. The processors and memory can be implemented using one or more devices, such as devices in a client-server implementation. The memory can include one or more devices (e.g., random access memory (RAM), read-only memory (ROM), flash memory, hard disk storage) for storing data and computer code for completing and facilitating the various user or client processes, layers, and modules. The memory can be or include volatile memory or non-volatile memory and may include database components, object code components, script components, or any other type of information structure for supporting the various activities and information structures of the inventive concepts disclosed herein. The memory can be communicably connected to the processor and include computer code or instruction modules for executing one or more processes described herein. The memory can include various circuits, software engines, and/or modules that cause the processor to execute the systems and methods described herein, such as to cause the communication or processing of audio signals.

The controller 102 can include or be coupled with communications electronics. The communications electronics can conduct wired and/or wireless communications. For example, the communications electronics can include one or more wired (e.g., Ethernet, PCIe, or AXI) or wireless transceivers (e.g., a Wi-Fi transceiver, a Bluetooth transceiver, an NFC transceiver, or a cellular transceiver) to instantiate or interface with a network interface. The controller 102 may be in network communication or otherwise communicatively coupled with the user interface 104, sensors 106, fan 108, data source 152 etc. The controller 102 can cause one or more operations disclosed, such as by employing another element of the ventilation system 100. For example, operations disclosed by other elements of the data processing system may be initiated, scheduled, or otherwise managed by the controller 102.

The ventilation system 100 can include, interface with, or otherwise utilize at least one user interface 104. The user interface 104 can be disposed within the structure as fixed interface comprising one or more buttons, screens, or other input device (e.g., touchscreens). The user interface 104 can include a graphical user interface (GUI) presented on a device communicatively coupled to the ventilation system 100 via a network such as a local network or the internet. For example, the user interface 104 may include a GUI presented on a tablet, smartphone, desktop or laptop computer, or other computing device which may be located within the structure or remote therefrom.

The user interface 104 can prompt a user to provide occupant data 126 or structure data 124. For example, the user interface 104 can present a prompt for information, and receive a reply to the prompt including the occupant data 126 or structure data 124. The user interface 104 can receive a number or type of occupants, and any associated equipment or activities. The user interface 104 can receive a start or end date for occupant data 126 or structure data 124. For example, the user interface 104 can receive an indication that a structure will have three human occupants, and one medium sized dog, that two of the occupants are non-smokers and another is a smoker, that the occupants will maintain flowers in the home, and use a wood burning fireplace about once a week between October and February. The user interface 104 can further receive an indication that the structure is a freestanding structure of residential construction.

The user interface 104 can include one or more access control levels. For example, the user interface 104 can include a first access control level available to an installer for setting up a device or at a service appointment which limits information presented (e.g., occupant data 126), and a second access control level to present to a user which may present a number or characteristics of current occupants, and thereafter, receive adjustments thereto. The user interface 104 can exchange information with a mobile device (e.g., information pushed or pulled from a mobile application, text messages such as SMS or MMS, etc.).

The ventilation system 100 can include, interface with, or otherwise utilize at least one sensor 106 designed, constructed, or operational to generate sensor data indicative of air within a structure or the environment exterior thereto. The sensor 106 can be located without or outside of the structure. The sensor 106 may be configured to determine information inside (e.g., particulate count) or outside of the structure. For example, a sensor 106 can include a temperature sensor 106, wind sensor 106, particulate matter sensor 106 to detect a quantity or type of particulate matter. Some sensors 106 can determine information by processing information from one or more sources. For example, the controller 102 can instantiate the sensors 106. A wind speed senor 106 can determine a wind speed based on a time average of wind speeds recorded by a local anemometer, or based on sensor data received from a remote sensor 106 (e.g., a sensor 106 associated with a weather service).

An airflow sensor 106 can determine a rate of air exchange between a structure and an environment. For example, the airflow sensor 106 can receive weather data 128 from a weather service, and structure data 124 to determine an expected airflow between the structure and a surrounding environment. Another airflow sensor 106 may determine an airflow by measuring a pressure proximal to the filter 110, which can be associated with an airflow through the filter 110.

A patriciate matter sensor 106 such as an optical or gravimetric particulate counter can determine a measure of particulate matter such as concentration. A particulate flow sensor 106 can determine an exchange of particulate matter between the environment and the structure based on, for example, the airflow determined by the airflow sensor 106. For example, the particulate flow sensor 106 can receive an indication of the particulate matter generated by one or more sources interior or exterior to the structure. The indication can be a particulate measurement, such as a pollen count or other data, such as a wind speed or humidity level. The particulate flow sensor 106 can determine the exchange based on a difference or gradient between the structure and the surrounding environment, and the structure data 124.

The ventilation system 100 can include, interface with, or otherwise utilize at least one fan 108 designed, constructed, or operational to pass air over a filter 110. Although various embodiments may employ a combination of fans 108, such as a separate inlet and outlet fans 108, recirculation fans 108, and so forth, the fans 108 may be referred to in the singular to refer to the net operation of the one or more fans 108. The fan 108 may pass air along a ducting or another passage including one or more filters 110. The fan 108 may be electrically or communicatively coupled with the controller 102. For example, the controller 102 can control an output to the fan 108, such that the controller 102 can determine a time of fan operation. The current supplied to the fan 108 may correlate to a pressure gradient along a passage (e.g., may consume higher power for clogged filters 110 such that the controller 102 may employ the fan 108 as a pressure sensor 106). The controller 102 may engage the fan 108 separately from other components of the ventilation system 100. For example, some embodiments, can include a heating mode, a cooling mode, and a recirculation mode. Some fans 108 may be configured to exchange air between a structure and an environment, or within a structure. Such fans 108 may increase or decrease particulate matter concentration in the structure (e.g., may change a rate of particulate matter settling or exchange of air with an environment).

The ventilation system 100 can include, interface with, or otherwise utilize at least one filter 110 designed, constructed, or operational to collect particulate matter entrained in an airflow there-through. For example, the filter 110 can be disposed along a same passage as the fan 108. The filter 110 can include an input face configured to receive airflow and an output face, opposite the input face. The filter 110 can be associated with an effective surface area (e.g., of pleats or other features). The filter 110 may include a layered structure wherein each layer is configured to capture particulate matter of a different type (e.g., a rough mesh to capture large particles such as hair, a carbon layer to absorb volatile organic compound, and a charged electrostatic layer to capture allergens, bacteria, or other small particles). One or more filters 110 may include one or more layers. For example, a first filter 110 (sometimes referred to as a “pre-filter”) and second filter 110 can be monitored or serviced separately. References to a filter 110 may refer to one or more such filters 110. For example, an indication of a predicted service date may refer to a first filter 110, a second filter 110, or both filters 110.

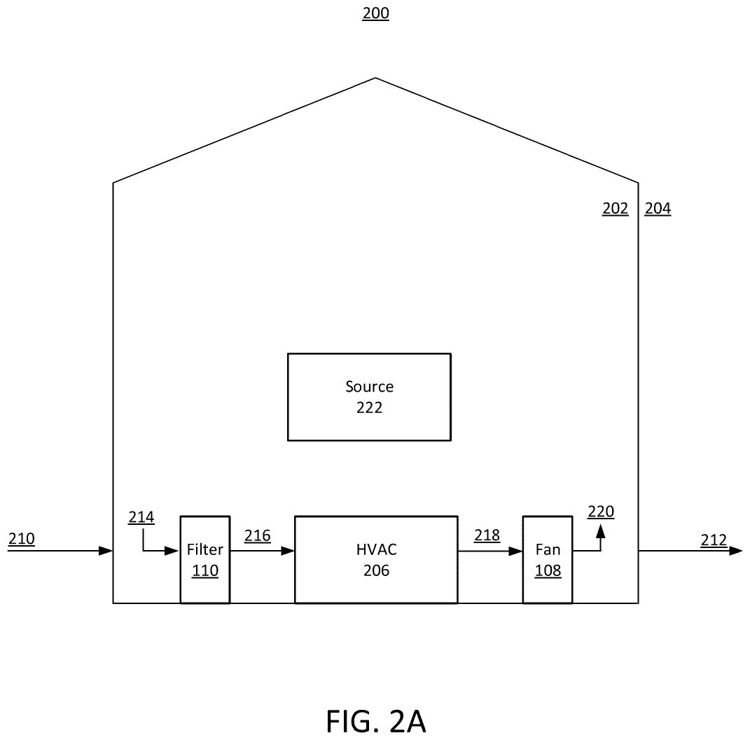

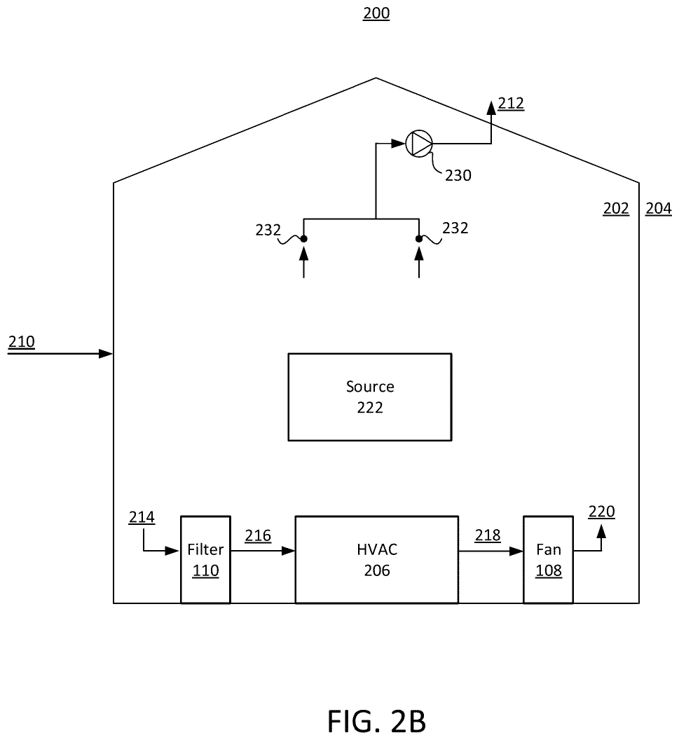

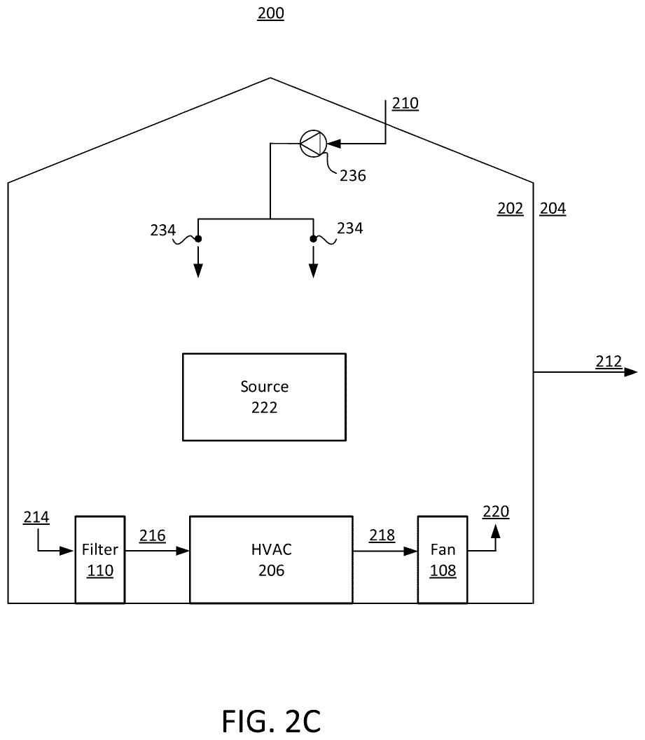

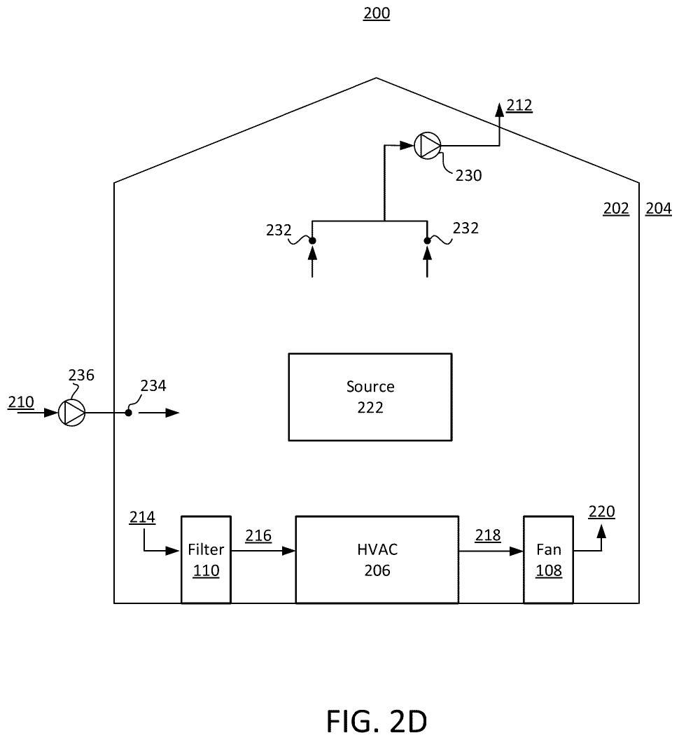

FIG. 2A is a depiction of a flow model 200 including a structure 202 disposed within an environment 204, according to an embodiment of the present disclosure. The depicted structure 202 includes a heating, ventilation, and/or air conditioning unit (HVAC unit 206). According to various embodiments, the HVAC 206 may include a heating portion, cooling portion, humidification portion, dehumidification portion, and so forth. For example, some embodiments may be or include an air purifier consisting essentially of the filter 110 and the fan 108. Some embodiments may include additional fans 108 or filters 110 such as separate inlet and outlet fans 108, or various filters 110 or fans 108 for separate zones of a zone climate control system. The structure 202 may be associated with a concentration of particulate matter. For example, the concentration of particulate matter may vary for various particulate sizes or types. The controller 102 can determine a rate of generation of one or more particulate matter types within the structure 202 (e.g., a number of grams per second). The controller 102 can determine the amount based on the occupant data 126. For example, the controller 102 can determine an amount of particulate matter in a range of 10-20 microns in a home with many dogs may be elevated relative to a baseline, or that an amount of particulate matter in a range of 0.1-0.2 microns in a home with a tobacco smoker be elevated relative to a baseline. The generation rate for particulate matter may be referred to herein as “G.” G may vary according to a particulate matter size or type, such correspondence may be depicted as, for example, G(dᵢ, t) where i refers to a type (e.g., size) of particle. The volume of the structure 202 may be referred to as “V.”

The flow model 200 includes various exchanges of particulate matter and air between the structure 202 and the environment 204. Particularly, the flow model 200 includes an air/particulate ingress 210 into the structure 202. The air/particulate ingress 210 may represent an aggregation of airflow paths from the environment 204 into the structure 202. For example, the air/particulate ingress 210 can include an aggregation of airflow, dust, etc. through various drafts, open doors or windows, air inlets, and so forth. The air/particulate ingress 210 may include one or more flow rates. For example, a rate of air/particulate ingress 210 can vary according to a particulate matter size. The flow model 200 includes an air/particulate egress 212 from the structure 202. The air/particulate egress 212 may include outflows from various sources, such as any of the ingress sources. A net air flow between the home and the environment 204, which may be referred to herein as “ [symbol] ₑₙᵥ” may represent a net of the air ingress and air egress. [symbol] ₑₙᵥ may be positive or negative, and may include positive of negative components from either of the air ingress or air egress.

The particulate matter ingress may depend on the concentration of particulate matter in an environment 204, other weather data 128 such as wind speeds, or structure data 124. The particulate ingress may be dependent on the air ingress or the air egress from the structure 202. For example, the particulate matter ingress may be described as a function of [symbol] ₑₙᵥ. One skilled in the art will understand that varying relationships between air movement and particulate matter movement may be described. For example, one relationship may correlate the net air flow to particulate matter exchange (e.g., ingress or egress), or may include other variables (e.g., based on a construction of the structure 202 which may include varying ingress according to a seasonality, wind direction, etc.). The air/particulate egress 212 from the structure 202 can include an outward flow of particulate matter. For example, a the flow model 200 can include a concentration of particulate matter within the structure 202, C(dᵢ, t), as determined by any particulate matter sources such as those associated with occupant data 126. The combination of the particulate matter egress and the particulate matter ingress may be referred to as net particulate flow, Cₑₙᵥ(dᵢ, t). For example, a separate net particulate flow can be determined for various particle types or characteristics.

The flow model 200 includes a flow through the ventilation system 100. For example, the flow can be directed by any ducting which may route airflow through the ventilation system. For example, one or more air inlets 214, (also referred to as air returns) can receive air from within a structure 202, and convey the air to another portion of the ventilation system 100. Air inlets 214 can include a selection from various air inlets 214 such as air inlets 214 proximal to a floor or ceiling corresponding to seasonality or current temperature data. In the depicted flow model 200, the air is conveyed to the filter 110, though air routing can vary according to various embodiments. The filter 110 collects particulate matter from the air such that a filter output 216 includes less particulate matter than a filter input (e.g., the air inlet 214, as depicted). The flow of the air through the filter 110 and the efficiency of filter collection may vary according to a filter service life. For example, as a filter accumulates particulate matter, the airflow through the filter may decrease, which may in turn decrease a rate of accumulation of the particulate matter for at least some particle sizes. The filtration efficiency for one or more particulate types may be referred to η, where an η of 1 correspond to 100% of particles (or particle types) accumulating on the filter 110 to remove from airflow, and an η of 0 corresponds to no particles (or particle types) being removed from airflow. Thus, for air entering the filter 110 having a concentration of C(d, t), the air exiting the filter 110 will have a concentration of C(d, t)(1−η). Such efficiency may vary over time, such as to trend downward as a filter accumulates particulate matter.

An HVAC unit 206 can condition a humidity, temperature, or other portion of the air which may affect (e.g., increase or decrease) a particulate matter concentration. That is, an HVAC 206 can be a source 222 for particulate matter. For example, a coal boiler may contribute particulate matter such as coal dust to the air. The HVAC unit 206 can provide an output 218 to the fan 108. The fan 108 can engage to cause or increase the airflow through the ventilation system. However, as described above, the airflow may also depend on the filter condition. An output 220 from the fan 108 can exhaust to an interior of the structure 202 or directly to the environment 204. According to the above disclosure, a rate of change of the concentration of one or more particle types, with respect to time, may be provided as follows:

$$\frac{dC ( {d}_{i} , t )}{dt} = \frac{{\dot{Q}}_{env}}{V} {C}_{env ( {d}_{i} , t )} - \frac{{\dot{Q}}_{env} + \dot{Q} η ( {d}_{i} , t )}{V} {C}_{env ( {d}_{i} , t )} + \frac{G ( {d}_{i} , t )}{V}$$

According to various embodiments, air/particulate ingresses 210 and egresses 212 can include various inlets, vents, or other elements configured to exchange air between a structure 202 and an environment 204. For example, FIG. 2B, FIG. 2C, and FIG. 2D depict various instances of flow models 200 for a structure 202. Referring now to FIG. 2B, an exhaust blower 230 (e.g., an instance of the fan 108) is configured to exhaust air from the structure 202. Such a configuration may be termed as exhaust ventilation. One or more exhaust vents 232 coupled to the exhaust blower 230 can be disposed throughout the structure. For example, the exhaust vents 232 can be disposed in areas proximal to sources 222 for particulate matter or moisture, such as bathrooms, kitchens, and utility rooms. The exhaust blower 230 can expel indoor air to the environment 204, creating a negative pressure inside the structure 202. This negative pressure can draw outdoor air into the structure through passive vents, intentional openings, or incidental openings of the air/particulate ingress 210.

A ventilation system 100 is a system including one or more fluid circuits, such as any fluid circuit disclosed herein, including HVAC or other fluid circuits. For example, the depicted ventilation system 100 includes a first circuit extending from the environment 204 into the structure via air/particulate ingress 210 openings, and returning to the environment 204 via the exhaust blower 230, along exhaust vents 232 and air/particulate egress 212 openings. The depicted ventilation system 100 further includes a fluid circuit comprising an HVAC 206 component (e.g., an HVAC circuit). The HVAC circuit can ingest air or particulate matter from air inlets 214 for provision to a filter 110, whereupon a portion of the air and particulate matter pass over the filter 110 to a filter output 216 at an HVAC 206 component. An output 218 of the HVAC 206 component can be received by a fan 108 configured to pass air or particulate matter to an output 220 thereof. One or more fluid circuits can exchange air or particulate matter therebetween. For example, the air inlets 214 of the HVAC circuit can receive an input drawn from the openings of the air/particulate ingress 210 openings. In some embodiments, various circuits can include any number of input or outputs. For example, an HVAC circuit and another virtualization system 100 or portion thereof can include separate inlet or outlet vents to exchange air within a structure 202 or between a structure 202 and an environment 204.

Although the depicted blower 230 is illustrated separately from the HVAC 206 component (e.g., as a separate ventilation system for the structure 202), such a depiction is not intended to be limiting. The systems and methods of the present disclosure can be employed with various system, which can include various air/particulate ingress 210 or egress 212 portions, such as coupled to an HVAC 206 or other ventilation system. For example, although not depicted, the exhaust blower 230 or other blowers can couple with a filter 110 to remove particulate matter, various sensors 106 to detect a pressure or airflow, etc. The filter 110 or other components can be a same or different filter 110 as is coupled with the depicted HVAC 206 component.

Referring now to FIG. 2C, another flow model 200 for a structure 202 is provided. The flow model 200 includes an inlet blower 236 configured to draw air into the structure 202 from the environment 204. Such a configuration may be termed as discharge ventilation. One or more inlet vents 234 coupled to the inlet blower 236 can be disposed throughout the structure. The inlet blower 236 drawing air into the structure 202 can create positive pressure inside the structure 202, such that the air in the structure 202 (e.g., including suspended particulate matter) can exit from the structure via various air/particulate egress 212 portions. Referring now to FIG. 2D, yet another flow model 200 for a structure 202 is provided. The flow model 200 includes an inlet blower 236 coupled to one or more inlet vents 234 and an exhaust blower 230 coupled to one or more exhaust vents 232. Such a configuration may be termed as balanced ventilation, wherein at least a portion of air/particulate ingress 210 provided by an active element such as a blower is offset by an air/particulate egress 212 provided by such an active element. The air/particulate ingress 210 and egress 212, depicted as coupled to the respective blowers 230, 236 are not intended to be exclusive of other vectors for air or particulate matter exchange. Various drafts, such as doors or windows can further exchange air, such as in response to imbalances between the blowers 230, 236, localized pressures, etc.

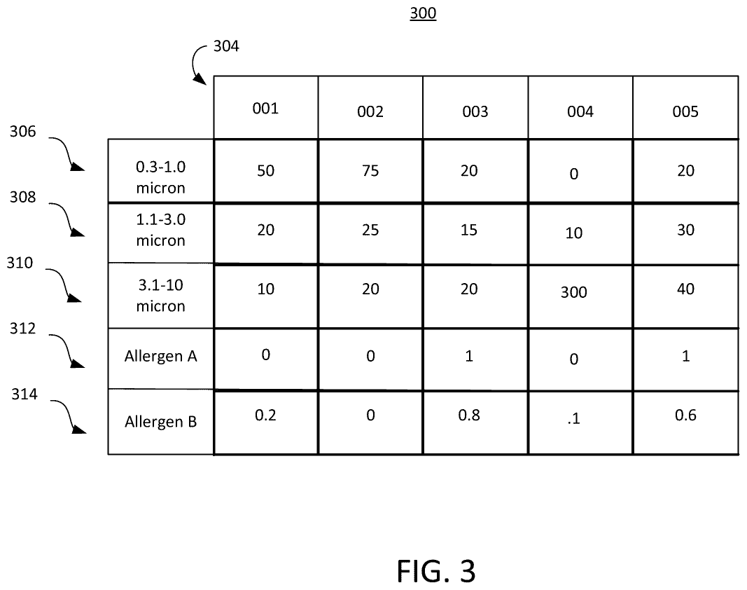

FIG. 3 is a data structure 300 including particulate matter generation information for various particulate matter sources within the structure 202. For example, the particulate matter sources can include human occupants, pets, appliances, or so forth. In some embodiments, the data structure 300 can include forms other than the depicted table, such as functions based on weight, size, frequency of occupancy or use, fuel type, etc.

The data structure 300 can include a particulate matter index 304 including any number of particulate matter sources. For example, the particulate matter index 304 may corresponds to a selection provided via the user interface 104. For example, the index value 001 may correspond to an adult, index value 002 may correspond to medium sized dog, and index value 004 may correspond to a wood fireplace. Each index value may correspond to a quantity or type of particulate matter generated. The value may vary over location, weather conditions, or the like. For example, a fireplace or person may generate more particulate matter in the winter (e.g., due to more frequent use or dry skin, respectively). The quantity of particulate matter may be defined according to a type such as a size or an allergenic profile. For example, a first quantity 306 may correspond to particulate matter having a first size, a second quantity 308 may correspond to particulate matter having a second size, and a third quantity 310 may correspond to particulate matter having a third size.

A type of a particulate matter may include an allergenic profile such as a Boolean indication of an allergen 312, an indication of a type of an allergen (e.g., rabbit dander, cat dander, pollen, or fragrances), which may correspond to a selection on the user interface 104 such that an occupant (or combination of occupants) having an allergy to, for example, pollen but not cat dander can indicate their sensitivity. The controller may predict a service life for a filter 110 or operate the fan 108 responsive to such information. The type of the particulate matter may include a specific concentration of an allergen. For example, sunflowers may produce large quantities of pollen which is not particular allergenic while geraniums may produce small quantities of pollen which can be highly allergenic. The data structure 300 can include an allergen concentration value 314. In some embodiments, the allergen concentration value 314 is normalized to one such that 1 gram of particulate matter with an allergen concentration value 314 of 0.5 can be equally allergenic to 2 grams of another particulate matter with an allergen concentration value 314 of 0.25.

Further tables, functions, or other representations of information can be associated with a concentration or production of particulate matter outside a structure 202, or with an exchange of air therebetween.

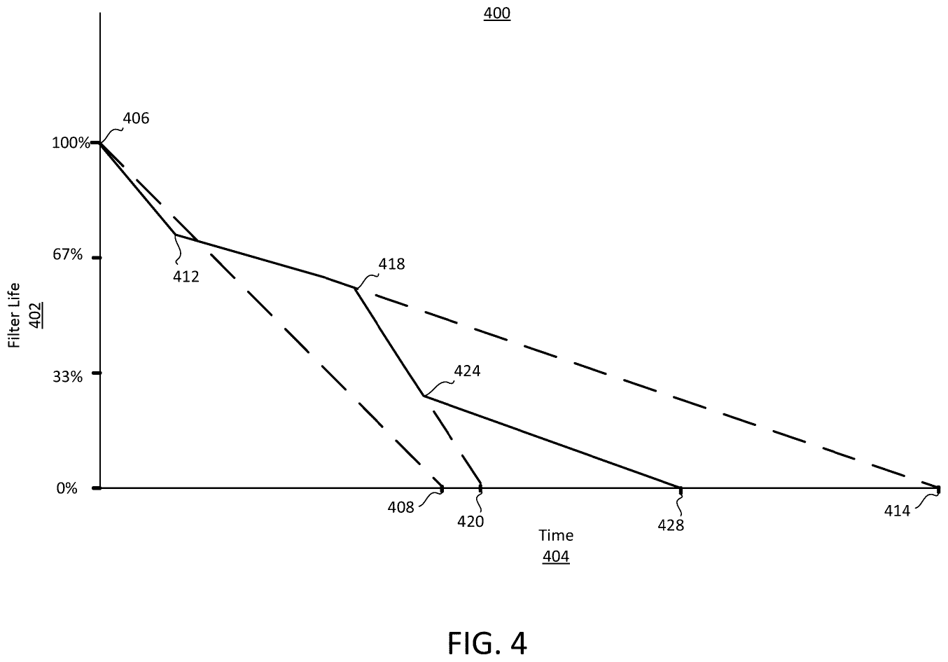

FIG. 4 is a filter life graph 400 providing various estimations of filter life over time, according to some embodiments. A filter life axis 402 depicts a remaining life of a filter 110. The filter life axis 402 may include a percent of filter life, a pressure differential between in input and output face of the filer, a quantity of particulate matter loaded in the filter 110, or so forth. The filter life may vary according to a filter size or preference. For example, a filter 110 may accumulate dust such that the filter 110 is effective for some particle types but not others (e.g., according to a size or electrostatic charge). The filter life may indicate a time to a service such as a replacement or washing of the filter 110. The filter life may be determined based on the filter properties 122, structure data 124, occupant data 126, or weather data 128. The time axis 404 may indicate a number of hours of runtime, or a calendar time, such as a month or day of the year corresponding to the current state of the filter 110 or a predicted service date.

Position 406 may refer to a filter 110 upon a filter service (e.g., a replaced or cleaned filter 110). The example, the filter life may correspond to a user entry provided via the user interface 104 indicative of changing the filter 110. The ventilation system 100 can predict a service life for the filter 110 upon installation or receipt if identification of the filter. For example, the prediction may be based on user entered data such as a number or type of particulate matter sources within the structure 202 (e.g., occupant data 126), a number or type of particulate matter sources in an environment 204 associated with the structure 202 (e.g., weather data 128, such as annual averages), and a rate of air exchange between the structure 202 and the surrounding environment 204. For example, the controller 102 can integrate C(dᵢ, t) over time to determine an amount of dust which can be expected to accumulate in the filter 110. The ventilation system 100 can predict the filter life based on one or more types of particulate matter. For example, the ventilation system 100 can sum C(dᵢ, t) for each type of particulate matter, i=1 . . . N, to determine a total amount of material. In some embodiments, an accumulation of one or more particulate types may be indicative of a time or type of service interval. Put differently, the collected particulate matter can be defined as Σᵢ₌₁^{i=N} ∫₀^{T}\dot{Q}(t)Ċ(d_{ι}, t)η(dᵢ, t)dt. For example, an accumulation of large particles may be indicative that a filter 110 can be blown out; an accumulation of fine particles may be indicative of a filter 110 that should be replaced before reaching a total mass of accumulated particulate matter. Based on the prediction, the ventilation system 100 can determine a first predicted service date 408 for the filter 110. The user interface 104 can convey the prediction to a user.

The first predicted service date 408 can correspond to an accumulation of particulate matter in the filter 110. For example, the controller 102 can determine a target amount of particulate matter (e.g., a total quantity or based on a particulate matter type). The time corresponding to the amount can determined by determining a termination of an integration period corresponding to the integral of C(dᵢ, t) indicated above which accumulates the target amount of particulate matter. Put differently, the optimal (or target) amount of particulate matter, Mₒₚₜ can be expressed as a function of the optimal (or target) time, Mₒₚₜ=Σᵢ₌₁^{i=N} ∫₀^{T}^{ₒₚₜ} \dot{Q}(t)Ċ(d_{ι}, t)η(dᵢ, t)dt. Thus, Tₒₚₜ may be a function of G, [symbol] ₑₙᵥ, Cₑₙᵥ, \dot{Q}, η, and V. For example, the controller 102 can determine various integrals for each C(dᵢ, t) corresponding various participial types, from i=1 . . . N. The controller 102 can determine the accumulated amount of particulate matter based on an accumulation reaching an accumulation threshold. For example, the controller 102 can compare accumulations for one or more particulate matter types to a corresponding accumulation threshold, or an accumulation sum to a total accumulation threshold. The controller 102 can determine a service, such as filter replacement or air blowing, based on the comparison to the threshold. The accumulation threshold may refer to a total accumulation on a filter 110, a surface area or volumetric ratio of particulate matter relative to the filter 110, a type of particulate matter, etc. The threshold may be referred to as Mₒₚₜ, which can include one or more subcomponents of M_{opt_i}, for i=1 . . . N. Mₒₚₜ may be received from an external data source, be determined based on filter properties or occupancy data (e.g., user preferences), or so forth. The offset time from a present time, from filter installation, or the predicted service date may be referred to as Tₒₚₜ, corresponding to Mₒₚₜ. In a non-limiting example, Tₒₚₜ is determined based on Mₒₚₜ, along with weights corresponding to each of occupant data 126 including a number of occupants, number of children, number of dogs, number of cats, and cooking activities; structure data 124 including building type and size; and filter properties 122. For example, the prediction may not be adjusted based on ongoing operating data. Such a time may be provided as a static time, e.g., T_{opt, static}.

Subsequent to predicting the first predicted service date 408, the ventilation system 100 can operate or receive current or historical information at position 412. For example, the controller 102 may receive an indication, from the external data source 152, the user interface 104 or from another portion of the ventilation system 100, that the fan 108, boiler, humidifier, etc. operated for fewer or additional hours than predicted, in a different mode (e.g., heating, cooling, humidifying, dehumidifying, etc.) or at a different speed; an occupant spent more in the residence than predicted; or weather data 128 (e.g., daily weather, a number of heating degree days or cooling degree days in a month, forecasted weather data) may vary from previous predictions. In some embodiments, a pressure sensor 106 may provide further indications of a state of a filter 110. Thus, the controller 102 can update the prediction. Such an updated prediction may be referred to as a dynamic prediction, T_{opt, dynamic}. T_{opt, dynamic} can be determined by multiplying a previous prediction (e.g., T_{opt, static}) by a dynamic correction factor, f_{dynamic}. The dynamic correction factor can depend on a fan run time ratio, fan speed level, HVAC operation mode, and so forth. For example, the controller 102 can determine that the filter usage corresponds to a second predicted service date 414. The user interface 104 can present the second predicted service date 414. Thereafter, the filter life may trend towards the second predicted service date 414. In some embodiments, the second predicted service date 414 may be generated responsive to a particulate matter sensor 106. For example, the particulate matter sensor 106 can detect particulate matter on a filter, in ductwork or another passage including the filter, or within other air in a structure.

At position 418, the controller 102 may receive an indication of a change to structure data 124 or occupant data 126 (e.g., from the user interface 104). For example, the controller 102 can receive an indication of a dog entering the home, a sensitivity of a user to an allergen, or a change in the construction of the home (e.g., increased insulation to inhibit airflow). Responsive to the received information, the controller 102 can predict the third predicted service date 420. The controller 102 can continue to adjust the predicted service date based on further information, including updates to models or other tables received from the external data sources 152, such as changes to an expected amount of particulate matter generated. For example, after the filter life trends toward the third predicted service date 420 (e.g., to position 424), the controller 102 can perform a periodic recalculation (e.g., based on time passed from a previous calculation, a looping process in instructions of a non-transitory memory, or responsive to a receipt of new information). As depicted, the controller 102 can determine a fourth predicted service date 428.

Upon reaching or approaching the predicted service date, the controller 102 may provide a further indication such as an audible or visual element of the user interface 104, a notification of an application of a mobile device, or the like. The controller 102 can latch the predicted service date at a point, such as 30 days prior to the predicted service date, 7 days prior to the predicted service date, or the like (e.g., to avoid confusion or changed dates). For example, upon conveying an alert to change the filter 110, the controller 102 can latch the predicted date, or apply a hysteresis value (e.g., at least one day, one week, one hour, etc.) to avoid spurious notification as the predicted service date jitters about a notification time period. In some embodiments, the predicted service date may not latch, and new notifications may not be generated in responsive to a change in the predicted service date.

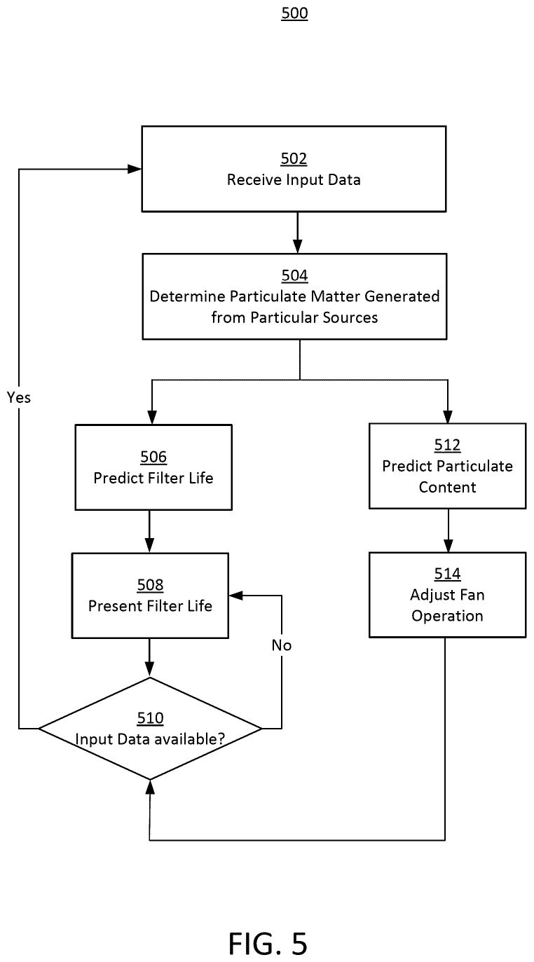

FIG. 5 is a method 500 of operating a ventilation system, according to an embodiment of the present disclosure. In brief summary, at operation 502, a controller 102 receives input data. At operation 504, the controller 102 determines particulate matter generated from particulate matter sources. At operation 506, the controller 102 predicts a filter life. At operation 508, the controller 102 presents a filter life via a user interface 104. At operation 510, the controller 102 determines whether further input data is available. At operation 512, the controller 102 predicts the particulate matter content within a structure 202. At operation 514, the controller 102 adjusts fan operation responsive to the particulate matter content.

Referring again to operation 502, the controller 102 receives input data. The input data can include information received from a user interface 104 (e.g., occupant data 126, filter properties 122, etc.), external data source (e.g., pollen count), or other component of the ventilation system (e.g., ventilation pressure, fan hour count, etc.). Some received information may be or include a default value. For example, the controller 102 can receive a default filter type having default filter properties 122, a default number of home occupant (e.g., 3.1 occupants), or a default volume of space within a home. The controller 102 can receive the default information from, for example, an external data source or a memory device of or interfacing with the ventilation system 100. Some received information may be received from an occupant or installer via the user interface 104. Some information may be received to replace older information. The access to read or modify various information may be controlled by one or more access control levels.

Referring again to operation 504, the controller 102 determines a measure (rate, concentration, or other amount) of particulate matter generated from particulate matter sources. For example, the controller 102 can determine a rate of particulate matter generation for one or more particulate types within a structure 202 based on the occupant data 126 and a concentration of particulate matter in an environment 204 around a structure 202 based on weather data 128. Some structures 202 may exchange air with an atmosphere including entrained particles at a rate which corresponds to information from structure data 124, or weather data 128. The measure of particulate matter may refer to a net amount based on a concentration of particulate matter within a structure 202 and a corresponding environment 204.

Referring again to operation 506, the controller 102 predicts a filter life. The controller 102 can predict the filter life based on the determination of the particulate matter of operation 504. For example, the filter life may be inversely correlated with net measure of particulate matter for one or more types. The filter life can be predicted based on filter properties 122.

Referring again to operation 508, the controller 102 presents a filter life via a user interface 104. The presentation may be based on a time to filter change, filter health, or the like. The display may be presented upon reaching a threshold (e.g., 30 or 60 days prior to a predicted service date). The display may be presented upon user access to a user interface 104 via a device in network communication with the ventilation system 100 such as a mobile device or laptop computer. The display may be presented via a user interface 104 within the structure 202, such as a panel mounted in proximity to other components of the ventilation system 100. The presentation may include audible presentation (e.g., tone or spoken voice) or visual presentation (e.g., LED or display screen).

Referring again to operation 510, the controller 102 determines whether updated input data is available. The determination may be responsive to a push or pull process. For example, a user or external data source 152 may push information to the controller 102 as it becomes available, or the controller 102 can periodically query various data sources 152 to determine a presence of updated information. The controller 102 can determine information corresponding to an operation of the ventilation system 100, such as a fan running time or speed based on other interactions with the fan 108. Responsive to determining no further input data is available, the controller 102 can continue to display a current indication of a predicted filter life. Responsive to determining further input data is available, the controller 102 can return to operation 502 to receive the further input data.

Referring again to operation 512, the controller 102 predicts a measure of particulate matter within a structure 202, such as a concentration. The controller 102 can determine the measure based on the volume or particulate sources. The controller 102 can determine a total amount, or an amount of one or more types of particulate matter.

Referring again to operation 514, the controller 102 adjusts fan operation responsive to the particulate levels. For example, the controller 102 can determine that the particulate matter concentration (e.g., for all particles, or allergenic particles) in the structure 202 exceeds a threshold. Responsive to the determination, the controller 102 can engage a fan 108 to pass air through the filter 110 to lower the particulate level in the air. For example, the controller 102 can cause the fan 108 to operate for a longer time during operation of a heating or cooling cycle of the ventilation system 100, or can operate the fan 108 independent of a heating or cooling cycle.

FIG. 6 is a block diagram illustrating an architecture for a computer system 600 that can be employed to implement elements of the systems and methods described and illustrated herein. The computer system or computing device 600 can include or be used to implement a controller 102 or its components, and components thereof. The computing system 600 includes at least one bus 605 or other communication component for communicating information and at least one processor 610 or processing circuit coupled to the bus 605 for processing information. The computing system 600 can also include one or more processors 610 or processing circuits coupled to the bus for processing information. The computing system 600 also includes at least one main memory 615, such as a random-access memory (RAM) or other dynamic storage device, coupled to the bus 605 for storing information, and instructions to be executed by the processor 610. The main memory 615 can be used for storing information during execution of instructions by the processor 610. The computing system 600 may further include at least one read only memory (ROM) 620 or other static storage device coupled to the bus 605 for storing static information and instructions for the processor 610. A storage device 625, such as a solid-state device, magnetic disk or optical disk, can be coupled to the bus 605 to persistently store information and instructions (e.g., for the data repository 120).

The computing system 600 may be coupled via the bus 605 to a display 635, such as a liquid crystal display, or active-matrix display. An input device 630, such as a keyboard or mouse may be coupled to the bus 605 for communicating information and commands to the processor 610. The input device 630 can include a touch screen display 635.

The processes, systems and methods described herein can be implemented by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes described herein. One or more processors in a multi-processing arrangement may also be employed to execute the instructions contained in main memory 615. Hard-wired circuitry can be used in place of, or in combination with, software instructions together with the systems and methods described herein. Systems and methods described herein are not limited to any specific combination of hardware circuitry and software.

Although an example computing system has been described in FIG. 6, the subject matter including the operations described in this specification can be implemented in other types of digital electronic circuitry, or in computer software, firmware, or hardware, including the structures disclosed in this specification and their structural equivalents, or in combinations of one or more of them.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components. For example, various devices of the systems herein can be fluidically coupled, wherein the devices transmit forces or exchange air without physical contact between the devices, such as with respect to air within a structure 202, within ducting thereof, or so forth.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

It is important to note that the construction and arrangement of the apparatus and control system as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method operations may be varied or re-sequenced according to alternative embodiments. Other substitutions, modifications, changes and omissions may also be made in the design, operating conditions and arrangement of the various exemplary embodiments without departing from the scope of the present application. For example, any element disclosed in one embodiment may be incorporated or utilized with any other embodiment disclosed herein.

What is claimed is:

1. A system for ventilation, the system including one or more processors coupled to memory, the one or more processors configured to:
determine a first measure of particulate matter generated from particulate sources disposed within a structure based at least in part on occupant data for the structure;
determine a second measure of particulate matter generated from an environment comprising particulate sources disposed outside the structure;
predict a service life for a filter based at least in part on the first measure of particulate matter, the second measure of particulate matter, and properties of the filter; and
present an indication of the predicted service life for the filter.

2. The system of claim 1, wherein the second measure of particulate matter is determined based on predicted weather data.

3. The system of claim 1, wherein the one or more processors are configured to:
adjust a runtime for a fan based on the predicted service life of the filter.

4. The system of claim 1, wherein the one or more processors are configured to:
determine the second measure of particulate matter based at least in part on weather data; and
determine a rate of exchange for particulate matter conveyed between the environment and the structure based at least in part on the weather data,
wherein the predicted service life is based on the rate of exchange for particulate matter.

5. The system of claim 1, wherein the one or more processors are configured to:
receive an indication corresponding to a change to the particulate sources disposed within the structure;
predict a second service life based on the change to the particulate sources; and
present an indication of the second service life.

6. The system of claim 1, wherein at least one of the first measure of particulate matter or the second measure of particulate matter comprises a plurality of particulate matter types.

7. The system of claim 6, wherein the plurality of particulate matter types comprises:
an allergen; or
a first particulate matter size; and
a second particulate matter size, different from the first particulate matter size.

8. The system of claim 1, wherein the occupant data comprises a number of occupants of the structure.

9. The system of claim 1, wherein the second measure of particulate matter comprises an indication of ambient weather for the environment received via a network interface.

10. A method comprising:
determining, by one or more processors coupled to memory, a first measure of particulate matter generated from particulate sources disposed within a structure based at least in part on occupant data for the structure;
determining, by the one or more processors, a second measure of particulate matter generated from an environment comprising particulate sources disposed outside the structure;
predicting, by the one or more processors, a service life for a filter based at least in part on the first measure of particulate matter, the second measure of particulate matter, and properties of the filter; and
presenting, by the one or more processors, an indication of the predicted service life for the filter.

11. The method of claim 10, wherein the second measure of particulate matter is determined based on predicted weather data.

12. The method of claim 10, comprising:
adjusting, by the one or more processors, a runtime for a fan based on the predicted service life of the filter.

13. The method of claim 10, comprising:
determining, by the one or more processors, the second measure of particulate matter based at least in part on weather data; and
determining, by the one or more processors, a rate of exchange for particulate matter conveyed between the environment and the structure based at least in part on the weather data,
wherein the predicted service life is based on the rate of exchange for particulate matter.

14. The method of claim 10, comprising:
receiving, by the one or more processors, an indication corresponding to a change to the particulate sources disposed within the structure;
predict a second service life based on the change to the particulate sources; and
present an indication of the second service life.

15. The method of claim 10, wherein at least one of the first measure of particulate matter or the second measure of particulate matter comprises a plurality of particulate matter types.

16. The method of claim 15, wherein the plurality of particulate matter types comprises:
an allergen; or
a first particulate matter size; and
a second particulate matter size, different from the first particulate matter size.

17. The method of claim 10, wherein the occupant data comprises a number of occupants of the structure.

18. The method of claim 10, wherein the second measure of particulate matter comprises an indication of ambient weather for the environment received via a network interface.

19. A non-transitory computer-readable memory comprising computer-readable instructions stored thereon that, when executed by a processor of a ventilation system, cause the processor to:
determine a first measure of particulate matter generated from particulate sources disposed within a structure based at least in part on occupant data for the structure;
determine a second measure of particulate matter generated from an environment comprising particulate sources disposed outside the structure;
predict a service life for a filter based at least in part on the first measure of particulate matter, the second measure of particulate matter, and properties of the filter; and
present an indication of the predicted service life for the filter.

20. The system of claim 1, wherein the instructions comprise instructions to:
adjust a runtime for a fan based on the predicted service life of the filter;
receive an indication corresponding to a change to the particulate sources disposed within the structure;
predict a second service life based on the change to the particulate sources; and
present, via a user interface, an indication of the second service life.
